(19) United States
(12) Patent Application Publication
(10) Pub. No.: US 2025/0355658 A1
(43) Pub. Date: Nov. 20, 2025

(54) System and method for dynamic test script generation and execution for website performance improvement

(71) Applicant: Bank of America Corporation, Charlotte, NC (US)

(72) Inventors: Prabhakar Devisetty, Monroe Township, NJ (US); Silpa Mokkapati, Lawrenceville, NJ (US); Tirtha Pandya, Franklin Park, NJ (US); Jeonghoon Lee, East Brunswick, NJ (US); Geetha Dwarakapuram, Newton, PA (US); Yogi Ahuja, Warwick, PA (US); Veena Kedia, Hillsborough, NJ (US); Subhashish Panda, Plainsboro, NJ (US); Ayyappan Thirukkannan, Robbinsville, NJ (US); Deelip Dattaram Bandarkar, Maharashtra (IN); Muhammad Jadoon, Bear, DE (US); Nagrajeshwari Vernekar, Kendall Park, NJ (US); Kyle Golden, Milford, NJ (US)

(21) Appl. No.: 18/663,746

(22) Filed: May 14, 2024

(51) Int. Cl. G06F 8/65; G06F 8/30; G06F 9/455; G06F 11/36; G06F 16/957

(52) U.S. Cl. CPC G06F 8/65; G06F 8/30; G06F 9/455; G06F 11/3684; G06F 11/3688; G06F 11/3692; G06F 16/957

(57) ABSTRACT

A system for improving performance of a website is disclosed. The system detects web components associated with the website and determines conditional metrics. The conditional metrics indicate a range of conditions under which the performance of the website is evaluated. The system generates a set of test case scripts to emulate various user interactions with the website under various conditions according to one or more conditional metrics. The system executes a first test case script to emulate a first user interaction with a first web element under a first condition. The system determines that a result of the first test case script does not correspond to an expected output. In response, the system performs a corrective action, including updating a code portion associated with the first web element in the source code of the website to a code portion that is configured to provide the expected output.

### TECHNICAL FIELD

The present disclosure relates generally to source code anomaly detection and mitigation, and more specifically to a system and method for dynamic test script generation and execution for website performance improvement.

### BACKGROUND

Websites are designed to present various information to users. Websites include web components, such as buttons, links, text fields, and media items, such as images and videos, among others. Users can interact with various web components on websites to perform a desired action.

### SUMMARY

The disclosed system described in the present disclosure is particularly integrated into practical applications of improving the performance of a website and underlying functionalities of the website by detecting and mitigating potential anomalous web components associated with the website.

In current systems, when a website is developed and goes live, there may be one or more anomalies that were not caught and addressed during the development of the website. Furthermore, when a website goes live, many user interactions along with other conditions (e.g., system conditions and network conditions) that affect the performance and functioning of the website may vary. For example, the conditions may include network traffic in the network that facilitates the loading of the website on the computing device, a time of day when the website is accessed, a device type from which the website is accessed, a device capability (such as internet speed, web browser type and version, operating system type and version, etc.) of the computing device from which the website is accessed, among other conditions and metrics. The user interactions may include any type of user interactions with one or more web components, such as navigating to different web pages, clicking buttons, clicking links, filling out text fields, logging into a user profile, performing any other action (e.g., data entry, interacting with media web components, downloading a file) on the website, and the like.

Many functions of the website are not tested under many possible combinations of system conditions and user interactions in the current systems. The current systems are not configured to and do not allow for testing many possible combinations of system conditions, network conditions, and user interactions. This gap in testing of the website leads to undetected issues and malfunctions during the development phase of the website. Such undetected issues and malfunctions may lead to security breaches, malfunctions, errors, and anomalies (collectively referred to herein as anomalies), and they may surface when the website is accessed under certain untested conditions. There is a need for a more comprehensive and dynamic approach to test and validate website's functionalities across a broad range of system conditions, network conditions, and user interactions.

The disclosed system is configured to provide a solution to these and other technical problems arising in the realm of website development and evaluation techniques. For example, in some embodiments, the disclosed system is configured to determine a range of conditional metrics that include relevant user interactions, system conditions, and network conditions with respect to the website. For example, the conditional metrics may include network traffic, network bandwidth, server load, concurrent user sessions, browser compatibility, user location, device types, operating systems, user interactions, user interaction patterns (e.g., clicks, scrolls, navigation paths, etc.), input types (e.g., text entry, file uploads, interactive media usage), a service/product offered by the website, a timestamp when the website is accessed, a geographical location from where the website is accessed, device capability associated with a device (e.g., computing device) from which the website is accessed, among others. The disclosed system is configured to determine the conditional metrics based on historical accesses to the website, historical user interactions, and logs, among others. The disclosed system is configured to dynamically update the conditional metrics based on changes to the network, network traffic, access location, user interaction patterns, and other relevant factors that may vary over time. Thus, the dynamic and adaptive update process for the conditional metrics allows the disclosed system to adapt to more relevant and recent condition changes.

In some embodiments, the disclosed system is configured to determine a weight for each conditional metric based on the effect that it has on the performance of the website. The disclosed system may use the determined weights to determine the priority of test case scripts for testing the website under different conditions.

In some embodiments, the disclosed system is configured to generate a set of test case scripts based on the determined conditional metrics. Each test case script may include code for emulating a user interaction with the website under a respective condition, where the respective condition corresponds to a combination of one or more conditional metrics. For example, some test case scripts may simulate/emulate a high volume of network traffic when the website is accessed, various access locations for the website, various access times for the website, various device types, various device capabilities (e.g., internet speed, operating systems, web browsers, etc.), various user interactions with different web components, access to the website during peak and off-peak hours, etc. Each test case script is configured to test a specific aspect/function/web component of the website under a specific combination of conditional metrics. The disclosed system is configured to execute the test case scripts, for example, according to their determined priority levels. In this manner, the disclosed system is configured to detect an anomaly with respect to any aspect/function/web component of the website.

In response, the disclosed system is configured to mitigate the detected anomaly. For example, the disclosed system may execute a corrective action to mitigate the detected anomaly. In one example, assume that the disclosed system has detected an anomaly with respect to a web component (e.g., a button, a link, a text field, an interactive media file, a web application, etc.). In response, the disclosed system may identify the code portion associated with the anomalous web component from the source code of the website and update/replace the identified code portion with another, updated code portion that is configured to provide an expected output with respect to the web component in question. For example, the disclosed system may access a code repository where tested and vetted codes for different web components are stored and fetch the code that is configured to provide the expected output when the web component is accessed and interacted with on the website. In response, the disclosed system may update the code portion of the web component with the fetched code.

In this manner, the disclosed system proactively detects and mitigates anomalies associated with the website during the development of the website before it goes live. This reduces failures with respect to various web components of the website when the website goes live, in other words, put in production. Thus, by implementing the disclosed system, computational processing resources that would otherwise be spent on addressing and mitigating the undetected anomalies after the website goes live are reduced.

Furthermore, when the website goes live, many users may access the website. Thus, if anomalies associated with the website are not detected and not mitigated before the website has gone live, the undetected anomalies may cause real-world implications, such as website crashes, system crashes, and data breaches, among others. Thus, the disclosed system also improves data security and website reliability and reduces real-world implications caused by undetected anomalies associated with the website.

Furthermore, by implementing the disclosed system, network resources that would otherwise be spent for managing increased network traffic due to errors and retries to load the website are reduced. Furthermore, by implementing the disclosed system, network congestion is reduced as the disclosed system helps to reduce scenarios where users repeatedly attempt to access and interact with faulty web components of the website. Furthermore, by proactively detecting and mitigating the anomalies, the disclosed system reduces the network bandwidth that would otherwise be increased due to attempting to render faulty web components multiple times by multiple users.

In some embodiments, a system for improving the performance of a website comprises a memory operably coupled with a processor. The memory is configured to store source code associated with the website. The processor is configured to detect a set of web components that are present on the website, wherein the set of web components comprises at least one of a button, a text field, or a link. The processor is further configured to determine a set of conditional metrics associated with the website, wherein the set of conditional metrics indicates a range of conditions under which the performance of the website is evaluated. The set of conditional metrics comprises at least one of a service offered by the website, a timestamp when the website is accessed, a geographical location from where the website is accessed, a user interaction with the website, and a device capability associated with a device from which the website is accessed. The processor is further configured to generate a set of test case scripts to emulate various user interactions with the website under various conditions according to one or more of the set of conditional metrics, wherein each of the set of test case scripts indicates a respective user interaction with the website under a respective condition. The processor is further configured to execute a first test case script from among the set of test case scripts, wherein executing the first test case script comprises emulating a first user interaction with the website under a first condition. The first condition is from among the range of conditions indicated by the set of conditional metrics. The first user interaction with the website comprises an interaction with a first web element on the website. The processor is further configured to determine that the result of the first test case script does not correspond to an expected output. The processor is further configured to perform a corrective action in response to determining that the result of the first test case script does not correspond to the expected output. The corrective action comprises identifying a first code portion associated with the first web element in the source code of the website and updating the first code portion to a second code portion that is configured to provide the expected output.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to detect and mitigate anomalies associated with websites;

FIG. 2 illustrates an example operational flow of the system of FIG. 1; and

FIG. 3 illustrates an example flowchart of a method to detect and mitigate anomalies associated with websites.

### DETAILED DESCRIPTION

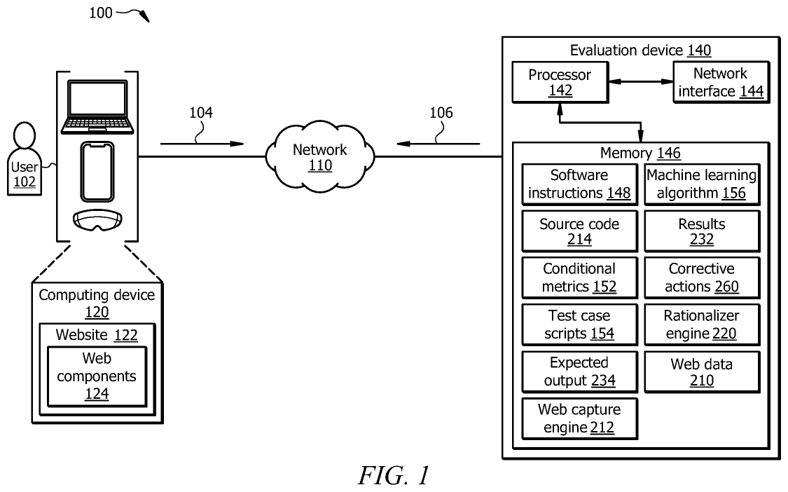

As described above, previous technologies fail to provide efficient and reliable solutions to detect and mitigate anomalies associated with websites. Embodiments of the present disclosure and its advantages may be understood by referring to FIGS. 1 through 3. FIGS. 1 through 3 are used to describe systems and methods to detect and mitigate anomalies associated with websites, according to some embodiments.

### System Overview

FIG. 1 illustrates an embodiment of a system 100 that is generally configured to detect and mitigate anomalies associated with websites, in other words, detect and mitigate anomalies in source code associated with each website. This, in turn, leads to improving the performance of the website. In some embodiments, the system 100 comprises an evaluation device 140 communicatively coupled with one or more computing devices 120 via a network 110. The network 110 enables the communication between the components of the system 100. A user 102 may use the computing device 120 to access a website 122, e.g., via a web browser application displayed on a screen of the computing device 120. When the website 122 is requested to be loaded on the screen of the computing device 120, a website load request 104 is sent to the evaluation device 140. The evaluation device 140 may fetch the web components 124 associated with the website 122. The web components 124 may include the Hyperlink Markup Language (HTML) files, Cascading Style Sheet (CSS) code, JavaScript files, images, and other web content. The evaluation device 140 may send the web content 106 that includes the fetched web components 124 to the computing device 120 so that the website 122 is rendered and loaded on the display screen of the computing device 120. In other embodiments, system 100 may include other elements instead of, or in addition to, those listed above.

In general, the system 100 improves the underlying functions of websites 122 by detecting user interactions on the websites 122, generating test case scripts to test the functioning of the website 122 under various user interactions, system conditions, network conditions (collectively referred to herein as test conditions) with respect to the websites 122, and detecting and mitigating potential anomalies in the source code of the website 122 that may lead to the website 122 not functioning as expected, i.e., failures and errors in the website 122.

In current systems, when a website 122 is developed and goes live, there may be one or more anomalies that were not caught and addressed during the development of the website 122. Furthermore, when the website 122 goes live, many user interactions along with other conditions (e.g., system conditions and network conditions) that affect the performance and functioning of the website 122 may vary. For example, the conditions may include network traffic in the network 110 that facilitates the loading of the website 122 on the computing device 120, a time of day when the website 122 is accessed, a device type from which the website 122 is accessed, a device capability (such as internet speed, web browser type and version, operating system type and version, etc.) of the computing device 120 from which the website 122 is accessed, among other conditions and metrics. The user interactions may include any type of user interactions with one or more web components 124, such as navigating to different web pages, clicking buttons, clicking links, filling out text fields, logging into a user profile, performing an action (e.g., data entry, interacting with media web components, downloading a file) on the website 122, and the like.

Many functions of the website 122 are not tested under many possible combinations of system conditions and user interactions in the current systems. The current systems are not configured to and do not allow for testing many possible combinations of system conditions, network conditions, and user interactions. This gap in testing of the website 122 leads to undetected issues and malfunctions during the development phase of the website 122. Such undetected issues and malfunctions may lead to security breaches, malfunctions, errors, and anomalies (collectively referred to herein as anomalies), and they may surface when the website 122 is accessed under certain untested conditions. There is a need for a more comprehensive and dynamic approach to test and validate website 122's functionalities across a broad range of system conditions, network conditions, and user interactions.

The disclosed system 100 is configured to provide a solution to these and other technical problems arising in the realm of website development and evaluation techniques. For example, in some embodiments, the disclosed system 100 is configured to determine a range of conditional metrics 152 that include relevant user interactions, system conditions, and network conditions with respect to the website 122. For example, the conditional metrics 152 may include network traffic, network bandwidth, server load, concurrent user sessions, browser compatibility, user location, device types, operating systems, user interactions, user interaction patterns (e.g., clicks, scrolls, navigation paths, etc.), input types (e.g., text entry, file uploads, interactive media usage), a service/product offered by the website 122, a timestamp when the website 122 is accessed, a geographical location from where the website 122 is accessed, device capability associated with a device (e.g., computing device 120) from which the website 122 is accessed, among others. The system 100 is configured to determine the conditional metrics 152 based on historical accesses to the website 122, historical user interactions, and logs, among others. The system 100 is configured to dynamically update the conditional metrics 152 based on changes to the network 110, network traffic, access location, user interaction patterns, and other relevant factors that may vary over time. Thus, the dynamic and adaptive update process for the conditional metrics 152 allows the system 100 to adapt to more relevant and recent condition changes.

In some embodiments, the system 100 is configured to determine a weight 224 for each conditional metric 152 based on the effect that it has on the performance of the website 122. The system 100 may use the determined weights 224 to determine the priority of test case scripts 154 for testing the website 122 under different conditions.

In some embodiments, the system 100 is configured to generate a set of test case scripts 154 based on the determined conditional metrics 152. Each test case script 154 may include code for emulating a user interaction 230 with the website 122 under a respective condition 228, where the respective condition 228 corresponds to a combination of one or more conditional metrics 152. For example, some test case scripts 154 may simulate/emulate a high volume of network traffic when the website 122 is accessed, various access locations for the website 122, various access times for the website 122, various device types, various device capabilities (e.g., internet speed, operating systems, web browsers, etc.), various user interactions with different web components 124, access to the website 122 during peak and off-peak hours, etc. Each test case script 154 is configured to test a specific aspect/function/web component 124 of the website 122 under a specific combination of conditional metrics 152. The system 100 is configured to execute the test case scripts 154, for example, according to their determined priority levels 236. In this manner, the system 100 is configured to detect an anomaly with respect to any aspect/function/web component 124 of the website 122.

In response, the system 100 is configured to mitigate the detected anomaly. For example, the system 100 may execute a corrective action 260 to mitigate the detected anomaly. In one example, assume that the system 100 has detected an anomaly with respect to a web component 124 (e.g., a button, a link, a text field, an interactive media file, a web application, etc.). In response, the system 100 may identify the code portion associated with the anomalous web component 124 from the source code of the website 122 and update/replace the identified code portion with another, updated code portion that is configured to provide an expected output with respect to the web component 124 in question. For example, the system 100 may access a code repository where tested and vetted codes for different web components 124 are stored and fetch the code that is configured to provide the expected output when the web component 124 is accessed and interacted with on the website 122. In response, the system 100 may update the code portion of the web component 124 with the fetched code.

In this manner, in some embodiments, the system 100 proactively detects and mitigates anomalies associated with the website 122 during the development of the website 122 before it goes live. This reduces failures with respect to various web components 124 of the website 122 when the website 122 goes live, in other words, put in production. Thus, by implementing the system 100, computational processing resources that would otherwise be spent on addressing and mitigating the undetected anomalies after the website 122 goes live are reduced.

When the website 122 goes live, many users may access the website 122. Thus, if anomalies associated with the website 122 are not detected and not mitigated before the website 122 has gone live, the undetected anomalies may cause real-world implications, such as website crashes, system crashes, data breaches, among others. Thus, the system 100 also improves data security and website reliability and reduces real-world implications caused by undetected anomalies associated with the website 122.

Furthermore, by implementing the system 100, network resources that would otherwise be spent for managing increased network traffic due to errors and retries to load the website 122 are reduced. Furthermore, by implementing the system 100, network congestion is reduced as the system 100 helps to reduce scenarios where users repeatedly attempt to access and interact with faulty web components 124 of the website 122. Furthermore, by proactively detecting and mitigating the anomalies, the system 100 reduces the network bandwidth that would otherwise be increased due to attempting to render faulty web components 124 multiple times by multiple users.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol as would be appreciated by one of ordinary skills in the art.

### Example Computing Device

Computing device 120 may generally be any device that is configured to process data and interact with users 102. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by user 102.

The computing device 120 may include a hardware processor, memory, and/or circuitry configured to perform any of the functions or actions of the computing device 120 described herein. For example, the computing device 120 includes a processor in signal communication with a network interface, and a memory. The memory stores software instructions (e.g., code) that when executed by the processor, cause the processor to perform one or more operations of the computing device 120 described herein.

The website 122 may be accessed on the computing device 120. For example, the computing device 120 may have a display screen on which the website 122 can be displayed and accessed. In example of the computing device 120 being a VR device, the website 122 may be displayed and accessed in a virtual reality environment. The user 102 may use user interfaces (e.g., keyboard, mouse, etc.) of the computing device 120 to open the website 122 on a web browser shown on the display screen of the computing device 120. For example, when the user 102 attempts to open the website 122 on the web browser, the computing device 120 sends the website load request 104 to the evaluation device 140 to render and load the website 122.

In response, the evaluation device 140 may fetch files that include the web components 124, HTML source code of the website 122, CSS code of the website 122, JavaScript files, images, and other web content. The evaluation device 140 may send the web content 106 that includes the fetched web components 124 to the computing device 120 so that the website 122 is rendered and loaded on the display screen of the computing device 120. In response to receiving the web content 106, the computing device 120 may use the received data to render and load the website 122 on the web browser.

### Evaluation Device

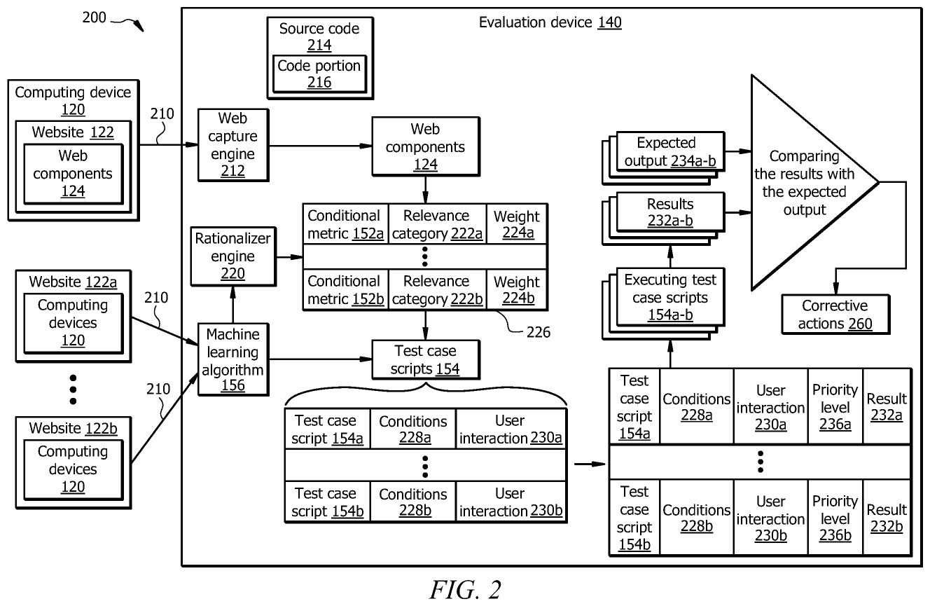

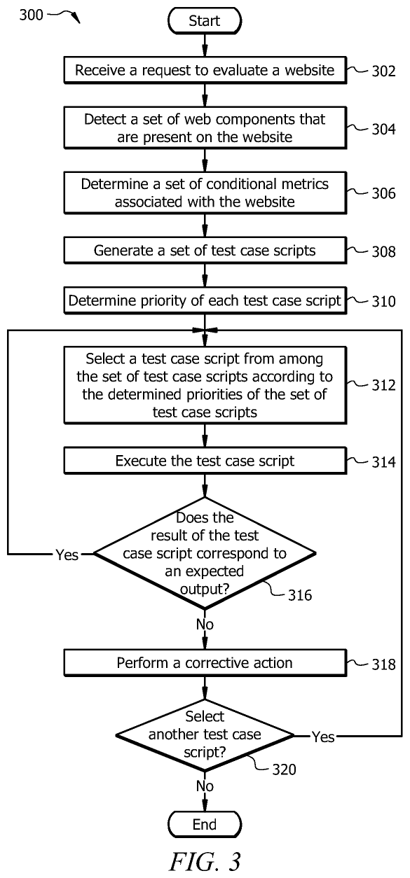

The evaluation device 140 may include one or more hardware computer systems, such as servers, virtual machines, etc. For example, the evaluation device 140 may be implemented by a plurality of computing devices using distributed computing and/or cloud computing systems in a network. In some embodiments, the evaluation device 140 may be a server in a server farm. The evaluation device 140 may be an instance of one or more servers. In certain embodiments, the evaluation device 140 may be configured to provide services and resources (e.g., data and/or hardware resources) to the components of the system 100. For example, the evaluation device 140 may provide web content 106, determine user interaction patterns with the website 122, determine conditional metrics 152, generate test case scripts 154, execute test case scripts 154, and detect and mitigate anomalies (e.g., errors) with respect to the website 122. These operations are described in conjunction with FIGS. 2 and 3.

The evaluation device 140 comprises a processor 142 operably coupled with a network interface 144 and a memory 146. Processor 142 comprises one or more processors. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and stores the results of ALU operations. The processor 142 may further include a control unit that fetches instructions from memory and executes them by directing the coordinated operations of the ALU, registers and other components. The one or more processors are configured to implement various software instructions. For example, the one or more processors are configured to execute instructions (e.g., software instructions 148) to perform the operations of the evaluation device 140 described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 described in FIG. 2, and one or more operations of the method 300 as described in FIG. 3.

Network interface 144 is configured to enable wired and/or wireless communications. The network interface 144 may be configured to communicate data between the evaluation device 140 and other devices, systems, or domains of the system 100. For example, the network interface 144 may comprise a near-field communication (NFC) interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and static random-access memory (SRAM). The memory 146 may include one or more of a local database, cloud database, network-attached storage (NAS), etc. The memory 146 comprises one or more disks, tape drives, or solid-state drives, and may be used as an over-flow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, conditional metrics 152, test case scripts 154, expected outputs 234, web capture engine 212, machine learning algorithm 156, results 232, corrective actions 260, rationalizer engine 220, source code 214 of the website 122, historical and current web data 210, and/or any other data or instructions. The software instructions 148 may comprise any suitable set of instructions, logic, rules, or code operable to execute the processor 142 and perform the functions described herein, such as some or all of those described in FIGS. 1-3. The source code 214 of the website 122 may include a set of code lines that when compiled and executed cause the website 122 to be rendered and loaded on a web browser and perform any function of the website 122.

The conditional metrics 152 may include any condition (e.g., system conditions, network conditions, user interactions, etc.) that may alter the state of the website 122, for example, a webpage being loaded, a web application being executed, a web component 124 being interacted with, etc. For example, the conditional metrics 152 may include network traffic, network bandwidth, server load, concurrent user sessions, browser compatibility, access location, device types, operating systems, user interactions, web component 124 type (e.g., a button, a text field, a link, a media file, such as video and image, etc.), user interaction patterns (e.g., clicks, scrolls, navigation paths, etc.), input types (e.g., text entry, file uploads, interactive media usage), a service/product offered by the website 122, a timestamp when the website 122 is accessed, a geographical location from where the website 122 is accessed, device capability associated with a device (e.g., computing device 120) from which the website 122 is accessed, among others.

In further examples, the conditional metrics 152 may include network performance metrics comprising a website load time, a server response time, a downtime frequency, and network traffic, content engagement metrics comprising a click-through rate, a time spent on the website 122, and an interaction rate with media elements on the website, technical device metrics comprising an operating system type and version, web browser type and version, etc.

The test case scripts 154 may be configured to test various user interactions, system conditions, and network conditions (collectively referred to herein as test conditions) with respect to the websites 122, and detecting and mitigating potential anomalies in the source code of the website 122 that may lead to the website 122 not functioning as expected, i.e., failures and errors in the website 122. The test case scripts may be generated based on the conditional metrics 152. Each test case script 154 may include code for emulating a respective user interaction 230 (see FIG. 2) with the website 122 under a respective condition 228 (see FIG. 2), where the respective condition corresponds to a combination of one or more conditional metrics 152. For example, some test case scripts 154 may simulate/emulate a high volume of network traffic when the website 122 is accessed, various access locations where the website 122 is accessed, various access times when the website 122 is accessed, various device types, various device capabilities (e.g., internet speed, operating systems, web browsers, etc.), various user interactions with different web components 124, access to the website 122 during peak and off-peak hours, etc. Each test case script 154 is configured to test a specific aspect/function/web component 124 of the website 122 under a specific combination of conditional metrics 152. The test case scripts 154 may correspond to real-world conditions that the website 122 may go through (e.g., conditions that the users 102 would experience on the website 122).

Machine learning algorithm 156 may be implemented by the processor 142 executing the software instructions 148 and is generally configured to generate the test case scripts 154. The machine learning algorithm 156 may comprise a support vector machine, neural network, random forest, k-means clustering, etc. The machine learning algorithm 156 may be implemented by a plurality of neural network (NN) layers, convolutional NN (CNN) layers, Long-Short-Term-Memory (LSTM) layers, Bi-directional LSTM layers, recurrent NN (RNN) layers, and the like. In some examples, the machine learning algorithm 156 may be implemented by natural language processing (NLP), data processing, text recognition, generative text processing, programming code processing, programming code generation, etc. In certain embodiments, the machine learning algorithm 156 may perform word segmentation, sentence segmentation, word tokenization, sentence tokenization, and analysis on a given data (e.g., historical web data 210, current web data 210, test conditions, system performance metrics, conditional metrics 152, web content 106, etc.) to detect patterns and associations across the given data. The machine learning algorithm 156 may use the detected patterns and associations across the given data to generate test case scripts 154 that are configured to create relevant test conditions 228 under which the website 122 to be tested. Such operations are described in greater detail in FIG. 2.

Web capture engine 212 may be implemented by the processor 142 executing the software instructions 148 and is generally configured to identify and capture web components 124 of the website 122. For example, the web capture engine 212 may include web crawler algorithms, computer vision algorithms, and the like. The operations of the web capture engine 212 are described in greater detail in FIG. 2.

Rationalizer engine 220 may be implemented by the processor 142 executing the software instructions 148 and is generally configured to determine the conditional metrics 152, their respective relevance category 222 (see FIG. 2) and weights 224 (see FIG. 2). In some embodiments, the rationalizer engine 220 may be implemented by and/or include a machine learning algorithm that may comprise a support vector machine, neural network, random forest, k-means clustering, etc. The operations of the rationalizer engine 220 are described in greater detail in FIG. 2.

### Operational Flow for Dynamic Test Script Generation and Execution for Website Performance Improvement

FIG. 2 illustrates an example operational flow 200 of the system 100 (see FIG. 1) for dynamic test script generation and execution for website performance improvement, according to certain embodiments. The operational flow 200 may begin when the evaluation device 140 captures and collects historical web data 210 associated with multiple websites 122a to 122b from multiple computing devices 120. The historical web data 210 may include historical user interactions, web events (events that alter the state of a respective website 122a-b), web components 124 of each website 122a-b, system conditions (e.g., device types, device capabilities, etc.). The evaluation device 140 may determine the network conditions associated with the historical web data 210 based on the historical web data 210. For example, the evaluation device 140 may determine network conditions, including network data bit rate, etc., based on the data rate, network bandwidth, and other characteristics under which the historical web data 210 is received.

Each website 122a-b may be accessed from a different computing device 120a-b. Each computing device 120a-b may be an instance of the computing device 120 described in FIG. 1. Each website 122a-b may be the same website as 122 described in FIG. 1 or may be a different website.

The historical web data 210 may be captured over time under different real-world conditions, such as different access locations, different network conditions, different access times, etc. The captured historical web data 210 may be fed to the machine learning algorithm 156. The machine learning algorithm 156 may analyze the captured historical web data 210 to identify patterns and anomalies within web components 124 and user interactions across the websites 122a-b. For example, the machine learning algorithm 156 may determine the relationship between the user interactions, real-world conditions (under which the website 122a-b is accessed), the outcome of the user interactions, and the performance of various web components 124 under different real-world conditions. In response, the machine learning algorithm 156 may identify more common user interactions on each website 1220a-b and the results of each user interaction. For example, for a website 122a where users can log in to their profiles and access their documents, a common user interaction with the website 122a may include user logging into their profile and accessing a document that is available on their profile. The machine learning algorithm 156 may use this information for generating more relevant test case scripts 154 that are more tailored to more common user interactions per website 122a-b.

### Capturing Web Components

In some embodiments, when a new website 122 is accessed by a user 102 from the computing device 120, the website load request 104 may be sent from the computing device 120 to the evaluation device 140 for evaluation. In some embodiments, one or more operations described herein may be performed during the development phase of the website 122 before the website 122 goes live. Thus, in such embodiments, the test case scripts 154 may be proactively generated and executed to detect and mitigate potential anomalies and errors with respect to the website 122 before the website 122 goes live. In some embodiments, one or more operations described herein may be performed before, during, and/or after the website 122 goes live, is requested to be loaded, e.g., put in production.

In the evaluation process of the website 122, the evaluation device 140 may detect web components 124 of the website 122 by implementing the web capture engine 212. In some embodiments, the evaluation device 140 (e.g., via the web capture engine 212) may detect the web components 124 by parsing the source code 214 of the website 122 and identifying the web components 124 that make up the structure and functions of the website 122, such as the HTML elements, CSS elements, among others. In this process, in some embodiments, the web capture engine 212 may execute a web crawler algorithm. In some embodiments, the evaluation device 140 (e.g., via the web capture engine 212) may detect the web components 124 from an image/video feed showing the website 122 over the user interaction period.

In the example where the computing device 120 is a VR device, it may have a camera. The camera may capture the image/video feed showing the website 122 displayed on the virtual environment that the VR device is showing on a virtual display/space. The web capture engine 212 may implement a computer vision algorithm, such as a web element detection algorithm and the like to detect the web components 124 that are shown on the captured image/video feed. In this process, the web element detection algorithm may perform image processing, edge detection, shape detection, etc. to extract features that indicate the visual and functional characteristics of the web components 124, such as edges, shapes, locations, etc. Based on the extracted features, the web element detection algorithm may identify the web components 124.

### Detecting Current User Interaction Patterns

In some embodiments, the evaluation device 140 may detect the current web data 210 associated with the website 122. The current web data 210 may include current user interaction patterns (e.g., user behavior, user navigation, and the like) on the website 122, and other information. For example, the evaluation device 140 may monitor the user interactions with the web components 124 on the website 122 based on changes to the state of the website 122, e.g., a button is pressed, a link is pressed, a text field is filled, etc.

The evaluation device 140 may detect user entries on various portions of the website 122. In an example, the evaluation device 140 may monitor the requests from the computing device 120 to the evaluation device 140 to determine the types of interactions that users 102 are engaging in and the specific web components 124 they are interacting with. This monitoring process includes tracking clicks, form submissions, page navigations, and any other actions that alter the state of the website 122. In response, the evaluation device 140 may determine the user behavior on the website 122, where the user behavior indicates the user traversing through the website 122 based on the detected user interactions with the web components 124.

The evaluation device 140 may determine the current network condition based on the current web data 210. For example, the evaluation device 140 may determine the current network conditions based on the data rate, network bandwidth, and other characteristics under which the current web data 210 is received. The current network condition of the network 110 may include network data bit rate, load at the servers that handle and maintain the website 122, such as evaluation device 140, network load, and concurrent user sessions at the website 122, among other information described herein.

The current web data 210 may further include other information, such as device attributes associated with the computing device 120, etc. The evaluation device 140 may detect the device attributes associated with the computing device 120 from which the website 122 is being accessed. The device attributes may, for example, include the type of the device (e.g., desktop computer, a mobile device, etc.), device capabilities, internet speed, operating system type and version, web browser type and version, etc.

The evaluation device 140 may detect the current web data 210 and network conditions from server load logs, user request logs, network condition logs, headers, and content of the network data packets that are communicated via the network 110 between the computing devices 120 and the evaluation device 140.

### Determining the Set of Conditional Metrics

In some embodiments, the evaluation device 140 may generate and determine the set of conditional metrics 152 associated with the website 122 based on the current and historical web data 210 (that include and/or are associated with current and historical network conditions, current and historical system conditions, current and historical device attributes, current and historical user interactions, etc.). The set of conditional metrics 152 may indicate a range of test conditions under which the performance of the website 122 is evaluated. Examples of the conditional metrics 152 are described in the description of FIG. 1.

In some embodiments, the evaluation device 140 may implement the rationalizer engine 220 to generate and determine the set of conditional metrics 152. In this process, the evaluation device 140 (e.g., via the rationalizer engine 220) may implement machine learning techniques to analyze the current and historical web data 210 to detect patterns and correlations between the user interactions with the website 122, conditions, outputs of the user interactions on the website 122, and performance of the website 122. In this process, the rationalizer engine 220 may extract features from the web data 210, where the features may be represented by numerical values in a feature vector. The features may indicate the web data 210, such as page load times, error rates, user interactions, etc. Each feature may be labeled with a specific identifier or category that reflects its relevance and impact on the website 122's performance. These categories may include system performance, user experience, security vulnerabilities, or operational efficiency, among others.

The rationalizer engine 220 may determine the correlations between each feature and its respective label. The rationalizer engine 220 may use this data as a training dataset to train its neural network to improve its accuracy in determining the effect of each feature on the website performance. The rationalizer engine 220 may determine the relevance category 222 and weight 224 for each conditional metric 152. For example, the rationalizer engine 220 may determine the relevance category 222a and weight 224a for the conditional metric 152a, and relevance category 222b and weight 224b for the conditional metric 152b. The relevance category 222 (e.g., any of relevance categories 222a-b) may indicate a type of device, access time, access location, language, etc., that is relevant to the respective conditional metric 152a-b. The weight 224 (e.g., any of the weights 224a-b) may indicate the importance and effect that the respective conditional metric 152a-b has on the performance of the website 122 and/or evaluating the performance of the website 122.

In one example, assume that the conditional metric 152a may be related to the user profile fields on the website 122 is experienced on and/or affect all types of devices, operating system types and versions. If the user profile field is not operating as expected (i.e., is anomalous), user information of a user may become available or shown to a different, wrong user. This may be an important issue that may cause security vulnerabilities on the website 122. Thus, the weight 224a of the conditional metric 152a may be set to a more than a threshold value, e.g., more than 8 out of 10. In another example, assume that the conditional metric 152a may be related to a redundant web component 124 (e.g., a redundant button) is experienced on and/or affect one type of device or one type and version of operating system, it may not be an important issue. Thus, the weight 224b of the conditional metric 152b may be set to less than a threshold value, e.g., less than 3 out of 10. Similarly, other weights 224 may be determined according to their respective conditional metric 152 and relevance category 222. The output of the rationalizer engine 220 may be table 226 which includes the conditional metrics 152a-b associated with the respective relevance category 222a-b and weight 224a-b. In some embodiments, the table 226 may be provided to the evaluation device 140 by an operator. In some embodiments, a training dataset comprising one or more tables 226 may be provided by a user to the evaluation device 140, where each table 226 may include some, a portion, or other data compared to the table 226 shown in FIG. 2. The evaluation device 140 may implement a supervised machine learning technique to learn the associations between each conditional metric 152 and its respective relevancy category 222 and weight 224 in each table of the training dataset. The evaluation device 140 (e.g., via the rationalizer engine 212) may use the learned associations to generate the table 226.

### Generating and Executing Test Case Scripts

The evaluation device 140 may use the table 226 to generate the test case scripts 154 to emulate various user interactions 230 with the website 122 under various conditions 228 according to one or more conditional metrics 152. In this process, the evaluation device 140 may feed the table 226, web data 210, and other data to the machine learning algorithm 156. The machine learning algorithm 156 may analyze the received data and generate the test scripts 154 by implementing text generating, code generating, natural language processing (NLP), and code synthesis techniques. For example, the machine learning algorithm 156 may generate a set of lines of code that follow a desired, predefined programming language structure, logic, and syntax, for each test case script 154. In this process, the machine learning algorithm 156 may generate test scripts 154 that follow, simulate, emulate the conditional metrics 152 identified in the table 226. The test scripts 154 simulate user interactions 230, test conditions 228 (e.g., including network conditions, device conditions, and other scenarios indicated by the relevance categories 222 and weights 224 in the table 226).

Each test script 154 (e.g., any of test scripts 154a-b) may indicate a respective user interaction 230 (e.g., user interaction 230a-b) with the website 122 under a respective test condition 228 (e.g., test conditions 228a-b). Each test condition 228a-b may be associated with and/or include any and any combination of the conditional metrics 152a-b. For example, a first test script 154a, when executed, may simulate conditions 228a (such as a high-traffic scenario during peak access times across multiple device types) and emulate user interaction 230 (e.g., concurrent data submissions through user profile fields) on the website 122. The test script 154a would trigger user interactions 230a, such as form submissions and login attempts. The test script 154s may output the result 232a of the user interaction 230a under the conditions 228a. The result 232a of the test script 154 may include response times, error rates, anomalies (if any), and performance of the website 122. Similarly, other test scripts 154 may emulate other conditions 228 and user interactions 230.

The evaluation device 140 may execute the test scripts 154a-b. In a particular example, assume that the first test script 154a may comprise code that when executed a first user interaction 230a with a first web component 124 under the conditions 228a is emulated on the website 122. The evaluation device 140 may execute the first test script 154a. In response, the evaluation device 140 may determine the result 232a of the first test script 154a. The result 232a of the test script 154a may indicate the outcome of the user interaction 230a on the website 122 and whether or not the website 122 performed as expected.

The evaluation device 140 may compare the result 232a with the counterpart expected output 234a associated with the user interaction 230a. For example, the counterpart expected output 234a may be identified and determined from historical web data 210 and historical performance of the website 122 when the user interaction 230a is performed on the website 122. If the evaluation device 140 determines that the result 232a corresponds to the counterpart expected output 234a, the evaluation device 140 may determine that the user interaction 230a under the condition 228a does not lead to or cause an error/anomaly on the website 122. If, however, the evaluation device 140 determines that the result 232a differs from the counterpart expected output 234a, the evaluation device 140 may determine that the user interaction 230a under the condition 228a leads to or causes an error/anomaly on the website 122.

### Mitigating Anomalies Detected by the Test Case Scripts

Continuing the example above with respect to the first test script 154a, in response to determining that the result 232a differs from the counterpart expected output 234a, the evaluation device 140 may perform a corrective action 260 to address and mitigate the detected anomaly. For example, the evaluation device 140 may identify the code portion 216 associated with the first web component 124 in the source code 214 of the website 122 and update the code portion 216 to a second code portion 216 that is configured to provide the counterpart expected output 234a.

In some embodiments, the evaluation device 140 may determine the results 232a by implementing text analysis and natural language processing algorithms to analyze the website event logs. In some embodiment, the evaluation device 140 may determine the counterpart expected output 234a by implementing text analysis and natural language processing algorithms to analyze the historical web data 210 (including historical website log events) when the user interaction 230a is performed on the website 122.

In some embodiments, the evaluation device 140 may compare the results 232a with the counterpart expected output 234a by implementing text analysis and natural language processing algorithms to extract contextual features from each of the results 232a and counterpart expected output 234a. The contextual features of the result 232a may indicate its context, meaning, etc., and are represented by a first feature vector comprising numerical values. The contextual features of the counterpart expected output 234a may indicate its context, meaning, etc., and are represented by a second feature vector comprising numerical values.

The evaluation device 140 may compare the first feature vector with the second feature vector to determine a similarity score between them. In this process, the evaluation device 140 may determine a distance (e.g., Euclidean distance) between the first and second feature vectors in the vector space. If the determined distance is less than a threshold distance (e.g., less than 0.1, 0.01, etc.), the evaluation device 140 may determine that the results 232a correspond to the counterpart expected output 234a. Otherwise, the evaluation device 140 may determine that the result 232a does not correspond with the counterpart expected output 234a.

In some embodiments, the corrective actions 260 may include deploying a security patch to be executed to address an anomaly that is related to a security vulnerability at the website 122. In some embodiments, the corrective actions 260 may include updating and/or changing one or more web components 124 to a known, vetted web component 124 to address an anomaly that is caused by incompatible web component 124 that is incompatible with the operating system version and/or type that is installed on the computing device 120. The present disclosure is not limited to these corrective actions 260 and contemplates any corrective actions 260 to address any anomaly and/or incompatibility associated with a web component 124.

Executing the Test Case Scripts Based on their Priorities

In some embodiments, the evaluation device 140 may determine priority levels 236a-b for the test scripts 154a-b, respectively, based on the respective weights 224a-b of each conditional metric 152a-b. The priority levels 236a-b may be proportional to the weights 224a-b, respectively. Each priority level 236a-b may indicate the importance of the respective test case 154a-b in evaluating the performance of the website 122 and detecting anomalies/errors with respect to the website 122. In one example, if the weight 224a for a conditional metric 152a is more than a threshold value (e.g., more than 8 out of 10), and the condition 228a includes the conditional metric 152a, the priority level 236a may be more than a threshold value (e.g., more than 8 out 10). Conversely, if the weight 224b for a conditional metric 152b is related to less critical aspects, such as the appearance of non-interactive web components 124 under specific conditions, is lower, then the priority level 236b for the corresponding test script 154b would be set lower.

In some embodiments, the evaluation device 140 may execute the test scripts 154a-b in descending order of their determined set of priority levels 232a-b. The evaluation device 140 may execute each test script 154a-b, determine the results 232a-b, compare each result 232a-b with the counterpart respective output 234a-b, and detect and mitigate respective anomalies, similar to that described above for the first test script 154a. For example, the evaluation device 140 may execute the test scripts 154a-b and determine the results 232a-b, respectively. The result 232a-b of the test script 154a-b may indicate the outcome of the user interaction 230a-b on the website 122 and whether or not the website 122 performed as expected, respectively. The evaluation device 140 may compare the result 232a-b with the counterpart expected output 234a-b associated with the user interaction 230a-b, respectively. For example, the counterpart expected output 234a-b may be identified and determined from historical web data 210 and the historical performance of the website 122 when the user interaction 230a-b is performed on the website 122, respectively.

If the evaluation device 140 determines that the result 232a-b corresponds to the counterpart expected output 234a-b, the evaluation device 140 may determine that the user interaction 230a-b under the condition 228a-b does not lead to or cause an error/anomaly on the website 122, respectively. If, however, the evaluation device 140 determines that the result 232a-b differs from the counterpart expected output 234a-b, the evaluation device 140 may determine that the user interaction 230a-b under the condition 228a-b leads to or cause an error/anomaly on the website 122, respectively.

### Example Method for Dynamic Test Script Generating and Execution for Website Performance Improvement

FIG. 3 illustrates an example flowchart of a method 300 for dynamic test script generating and execution for website performance improvement, according to some embodiments. Modifications, additions, or omissions may be made to method 300. Method 300 may include more, fewer, or other operations. For example, operations may be performed in parallel or in any suitable order. While at times, it is discussed that the system 100, evaluation device 140, or components of any of thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that when run by one or more processors (e.g., processor 142 of FIG. 1) may cause the one or more processors to perform operations 302-320.

At operation 302, the evaluation device 140 receives a request to evaluate a website 122. For example, the evaluation device 140 may receive the request when a user 102 attempts to load the website 122 on a web browser and the web data 210 is sent to the evaluation device 140, similar to that described in FIG. 2.

At operation 304, the evaluation device 140 detects a set of web components 124 that are present on the website 122. For example, the evaluation device 140 may implement the web capture engine 212 to detect the set of web components 124, similar to that described in FIG. 2.

At operation 306, the evaluation device 140 determines a set of conditional metrics 152 associated with the website 122. For example, the evaluation device 140 may implement the rationalizer engine 220 to determine the set of conditional metrics 152, similar to that described in FIG. 2.

At operation 308, the evaluation device 140 generates a set of test case scripts 154. For example, the evaluation device 140 may implement the machine learning algorithm 156 to generate the set of test case scripts 154, similar to that described in FIG. 2. At operation 310, the evaluation device 140 determines a priority level 236 of each test case script 154. For example, the evaluation device 140 may determine the priority levels 236 of each test case script 154 based on the weights 224, similar to that described in FIG. 2.

At operation 312, the evaluation device 140 selects a test case script 154 from among the set of test case scripts 154 according to the determined priority levels 236 of the set of test case script 154. For example, the evaluation device 140 may select a test case script 154 in descending order of the priority levels 236. The evaluation device 140 may iteratively select a test case script 154 until no test case script 154 is left to be executed.

At operation 314, the evaluation device 140 executes the test case script 154. For example, the evaluation device 140 may run the test case script 154, similar to that described in FIG. 2.

At operation 316, the evaluation device 140 determines whether the result 232 of the test case script 154 corresponds to the expected output 234. For example, the evaluation device 140 may compare the result 232 with the expected output 234, similar to that described in FIG. 2. If it is determined that the result 232 of the test case script 154 corresponds to the expected output 234, the method 300 returns to operation 312. Otherwise, the method 300 proceeds to operation 318.

At operation 318, the evaluation device 140 performs a corrective action 260. For example, the evaluation device 140 may update/replace a code portion 216 that is associated with an anomalous web component 124 with another code portion that is configured to provide the expected output 234 when the respective user interaction 230 is performed on the website 122, e.g., under the respective conditions 228.

At operation 320, the evaluation device 140 determines whether to select another test case script 154. The evaluation device 140 may determine to select another test case scripts 154 if at least one test case script 154 is left to be executed. If it is determined to select another test case script 154, the method 300 returns to operation 312. Otherwise, the method 300 ends.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for improving performance of a website, comprising:
a memory configured to store source code associated with a website; and
a processor, operably coupled to the memory, and configured to:
detect a set of web components that are present on the website, wherein the set of web components comprises at least one of a button, a text field, or a link;
determine a set of conditional metrics associated with the website, wherein:
the set of conditional metrics indicates a range of conditions under which performance of the website is evaluated; and
the set of conditional metrics comprises at least one of:
a service offered by the website;
a timestamp when the website is accessed;
a geographical location from where the website is accessed;
a user interaction with the website; or
a device capability associated with a device from which the website is accessed;
generate a set of test case scripts to emulate various user interactions with the website under various conditions according to one or more of the set of conditional metrics, wherein each of the set of test case scripts indicates a respective user interaction with the website under a respective condition;
execute a first test case script from among the set of test case scripts, wherein:
executing the first test case script comprises emulating a first user interaction with the website under a first condition;
the first condition is from among the range of conditions indicated by the set of conditional metrics; and
the first user interaction with the website comprises an interaction with a first web element on the website;
determine that a result of the first test case script does not correspond to an expected output; and
in response to determining that the result of the first test case script does not correspond to the expected output, perform a corrective action, wherein the corrective action comprises:
identifying a first code portion associated with the first web element in the source code of the website; and
updating the first code portion to a second code portion that is configured to provide the expected output.

2. The system of claim 1, wherein the processor is further configured to determine a set of weight values associated with the set of conditional metrics, wherein:
each of the set of weight values is associated with a respective conditional metric from among the set of conditional metrics; and
a weight value indicates an importance of the respective conditional metric in evaluating the performance of the website.

3. The system of claim 2, wherein the processor is further configured to:
determine, based at least in part upon the set of weight values, a set of priority levels for the set of test case scripts, wherein:
each priority level from among the set of priority levels is for a respective test case script; and
a priority level indicates an importance of the respective test case script in evaluating the performance of the website; and
execute the set of test case scripts in order of the determined set of priority levels.

4. The system of claim 1, wherein detecting the set of web components that are present on the website is in response to parsing the source code associated with the website.

5. The system of claim 1, wherein detecting the set of web components that are present on the website is in response to:
capturing an image of the website by a camera; and
implementing a web element detection algorithm to detect the set of web components that are shown on the captured image.

6. The system of claim 1, wherein determining the set of conditional metrics is in response to:
detecting the user interaction with at least a portion of the set of web components on the website; and
determining a user behavior on the website, wherein the user behavior indicates a user traversing through the website based at least in part upon the detected user interaction with at least the portion of the set of web components.

7. The system of claim 1, wherein the set of conditional metrics further comprises at least one of:
a network performance metric comprising at least one of a website load time, a server response time, a downtime frequency, or a network traffic;
a content engagement metric comprising at least one of a click-through rate, a time spent on the website, or an interaction rate with media elements on the website; or
a technical device metric comprising at least one of an operating system version or a web browser type.

8. A method for improving performance of a website, comprising:
detecting a set of web components that are present on a website, wherein the set of web components comprises at least one of a button, a text field, or a link;
determining a set of conditional metrics associated with the website, wherein:
the set of conditional metrics indicates a range of conditions under which performance of the website is evaluated; and
the set of conditional metrics comprises at least one of:
a service offered by the website;
a timestamp when the website is accessed;
a geographical location from where the website is accessed;
a user interaction with the website; or
a device capability associated with a device from which the website is accessed;
generating a set of test case scripts to emulate various user interactions with the website under various conditions according to one or more of the set of conditional metrics, wherein each of the set of test case scripts indicates a respective user interaction with the website under a respective condition;
executing a first test case script from among the set of test case scripts, wherein:
executing the first test case script comprises emulating a first user interaction with the website under a first condition;
the first condition is from among the range of conditions indicated by the set of conditional metrics; and
the first user interaction with the website comprises an interaction with a first web element on the website;
determining that a result of the first test case script does not correspond to an expected output; and
in response to determining that the result of the first test case script does not correspond to the expected output, performing a corrective action, wherein the corrective action comprises:
identifying a first code portion associated with the first web element in source code of the website; and
updating the first code portion to a second code portion that is configured to provide the expected output.

9. The method of claim 8, further comprising determining a set of weight values associated with the set of conditional metrics, wherein:
each of the set of weight values is associated with a respective conditional metric from among the set of conditional metrics; and
a weight value indicates an importance of the respective conditional metric in evaluating the performance of the website.

10. The method of claim 9, further comprising:
determining, based at least in part upon the set of weight values, a set of priority levels for the set of test case scripts, wherein:
each priority level from among the set of priority levels is for a respective test case script; and
a priority level indicates an importance of the respective test case script in evaluating the performance of the website; and
executing the set of test case scripts in order of the determined set of priority levels.

11. The method of claim 8, wherein detecting the set of web components that are present on the website is in response to parsing the source code associated with the website.

12. The method of claim 8, wherein detecting the set of web components that are present on the website is in response to:
capturing an image of the website by a camera; and
implementing a web element detection algorithm to detect the set of web components that are shown on the captured image.

13. The method of claim 8, wherein determining the set of conditional metrics is in response to:
detecting the user interaction with at least a portion of the set of web components on the website; and
determining a user behavior on the website, wherein the user behavior indicates a user traversing through the website based at least in part upon the detected user interaction with at least the portion of the set of web components.

14. The method of claim 8, wherein the set of conditional metrics further comprises at least one of:
a network performance metric comprising at least one of a website load time, a server response time, a downtime frequency, or a network traffic;
a content engagement metric comprising at least one of a click-through rate, a time spent on the website, or an interaction rate with media elements on the website; or
a technical device metric comprising at least one of an operating system version or a web browser type.

15. A non-transitory computer-readable medium storing instructions that, when executed by a processor, cause the processor to:
store source code associated with a website;
detect a set of web components that are present on the website, wherein the set of web components comprises at least one of a button, a text field, or a link;
determine a set of conditional metrics associated with the website, wherein:
the set of conditional metrics indicates a range of conditions under which performance of the website is evaluated; and
the set of conditional metrics comprises at least one of:
a service offered by the website;
a timestamp when the website is accessed;
a geographical location from where the website is accessed;
a user interaction with the website; or
a device capability associated with a device from which the website is accessed;
generate a set of test case scripts to emulate various user interactions with the website under various conditions according to one or more of the set of conditional metrics, wherein each of the set of test case scripts indicates a respective user interaction with the website under a respective condition;
execute a first test case script from among the set of test case scripts, wherein:
executing the first test case script comprises emulating a first user interaction with the website under a first condition;
the first condition is from among the range of conditions indicated by the set of conditional metrics; and
the first user interaction with the website comprises an interaction with a first web element on the website;
determine that a result of the first test case script does not correspond to an expected output; and
in response to determining that the result of the first test case script does not correspond to the expected output, perform a corrective action, wherein the corrective action comprises:
identifying a first code portion associated with the first web element in the source code of the website; and
updating the first code portion to a second code portion that is configured to provide the expected output.

16. The non-transitory computer-readable medium of claim 15, wherein the instructions further cause the processor to determine a set of weight values associated with the set of conditional metrics, wherein:
each of the set of weight values is associated with a respective conditional metric from among the set of conditional metrics; and
a weight value indicates an importance of the respective conditional metric in evaluating the performance of the website.

17. The non-transitory computer-readable medium of claim 16, wherein the instructions further cause the processor to:
determine, based at least in part upon the set of weight values, a set of priority levels for the set of test case scripts, wherein:
each priority level from among the set of priority levels is for a respective test case script; and
a priority level indicates an importance of the respective test case script in evaluating the performance of the website; and
execute the set of test case scripts in order of the determined set of priority levels.

18. The non-transitory computer-readable medium of claim 16, wherein detecting the set of web components that are present on the website is in response to parsing the source code associated with the website.

19. The non-transitory computer-readable medium of claim 15, wherein detecting the set of web components that are present on the website is in response to:
capturing an image of the website by a camera; and
implementing a web element detection algorithm to detect the set of web components that are shown on the captured image.

20. The non-transitory computer-readable medium of claim 15, wherein determining the set of conditional metrics is in response to:
detecting the user interaction with at least a portion of the set of web components on the website; and
determining a user behavior on the website, wherein the user behavior indicates a user traversing through the website based at least in part upon the detected user interaction with at least the portion of the set of web components.
